(19) United States
(12) Patent Application Publication
(10) Pub. No.: US 2008/0054175 A1
(43) Pub. Date: Mar. 6, 2008

(54) SYSTEMS AND METHODS FOR CORRECTING FOR UNEQUAL ION DISTRIBUTION ACROSS A MULTI-CHANNEL TOF DETECTOR

(76) Inventors: Nic Bloomfield, Newmarket (CA); Gordana Ivosev, Etobicoke (CA)

Correspondence Address: BERESKIN AND PARR, 40 KING STREET WEST, BOX 401, TORONTO, ON, M5H 3Y2, CA

(21) Appl. No.: 11/846,719

(22) Filed: Aug. 29, 2007

Related U.S. Application Data
(60) Provisional application No. 60/823,918, filed on Aug. 30, 2006.

(51) Int. Cl. G06F 19/00; H01J 49/26

(52) U.S. Cl. 250/287; 702/46

(57) ABSTRACT

Systems and methods for calculating ion flux. In one embodiment, a mass spectrometer includes an ion source for emitting a beam of ions from a sample and at least one detector positioned downstream of said ion source. The at least one detector comprises a plurality of detector channels. The mass spectrometer also includes a controller operatively coupled to the plurality of detector channels. The controller is configured to: determine ion abundance data correlated to each detector channel; determine corrected ion abundance data correlated to each detector channel; determine confidence data corresponding to the ion abundance data for each of the detector channels; and determine a confidence weighted abundance estimate of the ion flux correlated to both the ion abundance data and to the confidence data.

### FIELD OF THE INVENTION

The present invention relates generally to the field of mass spectrometry, with particular but by no means exclusive application to time-of-flight (TOF) mass spectrometers.

### BACKGROUND OF THE INVENTION

Mass spectrometers are used for producing mass spectrum of a sample to find its composition. This is normally achieved by ionizing the sample and separating ions of differing masses and recording their relative abundance by measuring intensities of ion flux. For example, with time-of-flight mass spectrometers, ions are pulsed to travel a predetermined flight path. The ions are then subsequently recorded by a detector. The amount of time that the ions take to reach the detector, the “time-of-flight”, may be used to calculate the ion's mass to charge ratio, m/z. A detector may have a plurality of channels, each separately recording ion impacts.

However, to date, TDC's typically used in mass spectrometers are not able to distinguish between the impact of one or more ions recorded by a single channel or anode during a specific segment of time. As a result, a specific channel of the detector is unable to determine if more than one ion has impacted with the detector during a bin period. Information is lost, reducing the dynamic range of the spectrometer.

As well, to date, optics are typically used to attempt to evenly distribute ions across the various channels of the detector. Despite these efforts, ion distribution is generally not uniform across the channels.

The applicants have accordingly recognized a need for new systems and methods for calculating ion flux in mass spectrometry.

### SUMMARY OF THE INVENTION

In one aspect, the present invention is directed towards a method for calculating ion flux using a mass spectrometer having a plurality of detector channels. The method includes the steps of:
(a) determining ion abundance data correlated to each detector channel;
(b) determining corrected ion abundance data correlated to each detector channel;
(c) determining confidence data corresponding to the ion abundance data for each detector channel;
(d) determining a confidence weighted ion abundance estimate of the ion flux for all of the detector channels correlated to both the ion abundance data and to the confidence data for each detector channel.

In another aspect, the invention is directed towards a method for calculating ion flux for a sample. The method includes the steps of:
(a) emitting ions from the sample during a plurality of pulses;
(b) detecting the impact of ions through a plurality of detector channels;
(c) determining ion abundance data correlated to each of the plurality of detector channels;
(d) determining corrected ion abundance data corresponding to each of the plurality of detector channels;
(e) determining confidence data corresponding to the ion abundance data for each of the selected plurality of detector channels; and
(f) determining a confidence weighted abundance estimate of the ion flux correlated to both the ion abundance data and to the confidence data.

In yet a further aspect, the present invention is directed towards a mass spectrometer. The mass spectrometer includes an ion source for emitting a beam of ions from a sample and at least one detector positioned downstream of said ion source. The at least one detector comprises a plurality of detector channels. The mass spectrometer also includes a controller operatively coupled to the plurality of detector channels. The controller is configured to:
(a) determine ion abundance data correlated to each detector channel;
(b) determine corrected ion abundance data correlated to each detector channel;
(c) determine confidence data corresponding to the ion abundance data for each of the detector channels; and
(d) determine a confidence weighted abundance estimate of the ion flux correlated to both the ion abundance data and to the confidence data.

### BRIEF DESCRIPTION OF THE DRAWINGS

The present invention will now be described, by way of example only, with reference to the following drawings, in which like reference numerals refer to like parts and in which:

FIG. 1 is a schematic diagram of a mass spectrometer made in accordance with the present invention;

FIG. 2A is a schematic diagram illustrating the unequal distribution of ions over four detector channels of the mass spectrometer of FIG. 1;

FIG. 2B is a schematic diagram of a TOF mass spectrum from the third channel of FIGS. 1 and 2A;

FIG. 3 is a flow diagram illustrating the steps of a method of measuring and calculating ion abundance data and confidence levels which may be used in accordance with the present invention; and

FIG. 4 is a flow diagram illustrating the steps of a method of calculating corrected abundance data in accordance with the present invention.

### DETAILED DESCRIPTION OF THE INVENTION

As used in the application,

“detector” means an ion detector which, either, outputs an analog signal or a digital signal corresponding to the number of ions measured by the detector;

“analysis period” means the time duration that the signal from the detector is used for the analysis;

“bin” means one or more segments of time of the analysis period so that the analysis period can comprise of one or a repeatable series of bins. Each bin can correspond to a specific m/z value or a range of m/z values;

“bin period” means the time duration of a single bin;

“beam of ions” means generally a discrete group of ions, a continuous stream of ions or a pseudo continuous stream of ions; and

“pulse” means generally any waveform used to cause ions to be emitted for the mass spectrometry analysis. A part of the pulse, such as the leading edge of the pulse, can be use to trigger the start of a series of bins. Similarly, a beam of ions can be pulsed so to produce a pulsed beam of ions, or further, a pulse can be use to trigger the analysis period of a beam of ions.

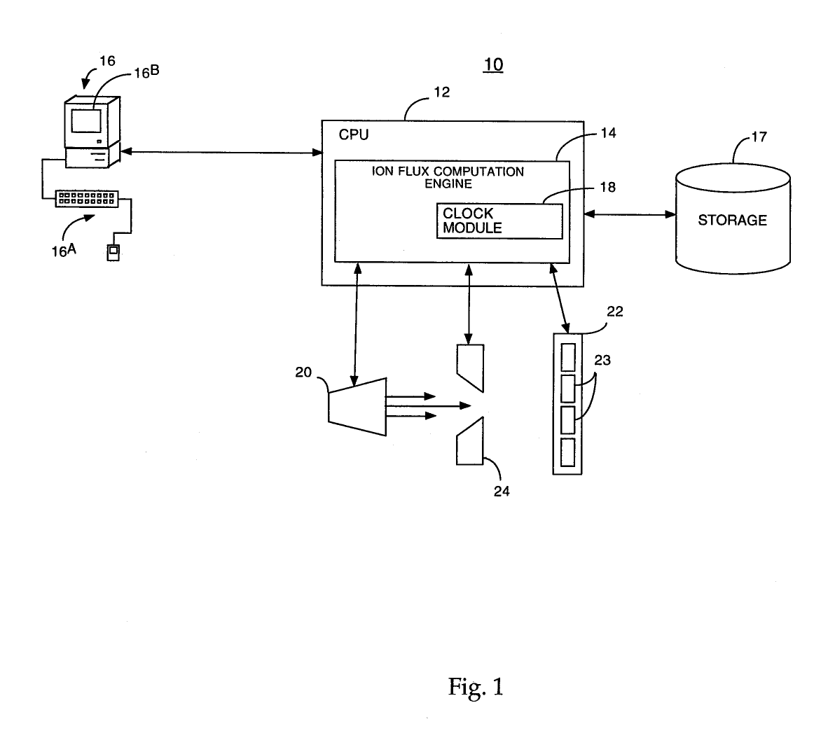

Referring to FIG. 1, illustrated therein is a TOF mass spectrometer, referred to generally as 10, made in accordance with the present invention. The spectrometer 10 comprises a processor or central processing unit (CPU) 12 having a suitably programmed ion flux computation engine 14. An input/output (I/O) device 16 (typically including an input component 16^{A} such as a keyboard or control buttons, and an output component such as a display 16^{B}) is also operatively coupled to the CPU 12. Data storage 17 is also preferably provided. The CPU 12 will also include a clock module 18 (which may form part of the computation engine 14) configured for determining a repeatable series of bins which will be discussed in greater detail, below.

The spectrometer 10 also includes an ion source 20, configured to emit a beam of ions, generated from the sample to be analyzed. As will be understood, the beam of ions from the ion source 20 can be in the form of a continuous stream of ions; or the stream can be pulsed to generate a pulsed beam of ions; or the ion source 20 can be configured to generate a series of pulses in which a pulsed beam of ions is emitted. Typically the number of pulses may be on the order of 10,000 during an analysis period, but this number can be increased or decreased depending on the application.

Accordingly, the ion source 20 can comprise of a continuous ion source, for example, such as an electron impact, chemical ionization, or field ionization ion sources (which may be used in conjunction with a gas chromatography source), or an electrospray or atmospheric pressure chemical ionization ion source (which may be used in conjunction with a liquid chromatography source), or a desorption electrospray ionization (DESI), or a laser desorption ionization source, as will be understood. A laser desorption ionization source, such as a matrix assisted laser desorption ionization (MALDI) can typically generate a series of pulses in which a pulsed beam of ions is emitted. The ion source 20 can also be provided with an ion transmission ion guide, such as a multipole ion guide, ring guide, or an ion mass filter, such as a quadrupole mass filter, or an ion trapping device, as generally know in the art (not shown). For brevity, the term ion source 20 has been used to describe the components which generate ions from the compound, and to make available the analyte ions of interest for detection. Other types of ion sources 20 may also be used, such as a system comprising of a tandem mass filter and ion trap.

A detector 22 (having a plurality of anodes or channels 23) is also provided, which can be positioned downstream of the ion source 20, in the path of the emitted ions. Optics 24 or other focusing elements, such as an electrostatic lens can also be disposed in the path of the emitted ions, between the ion source 20 and the detector 22, for focusing the ions onto the detector 22.

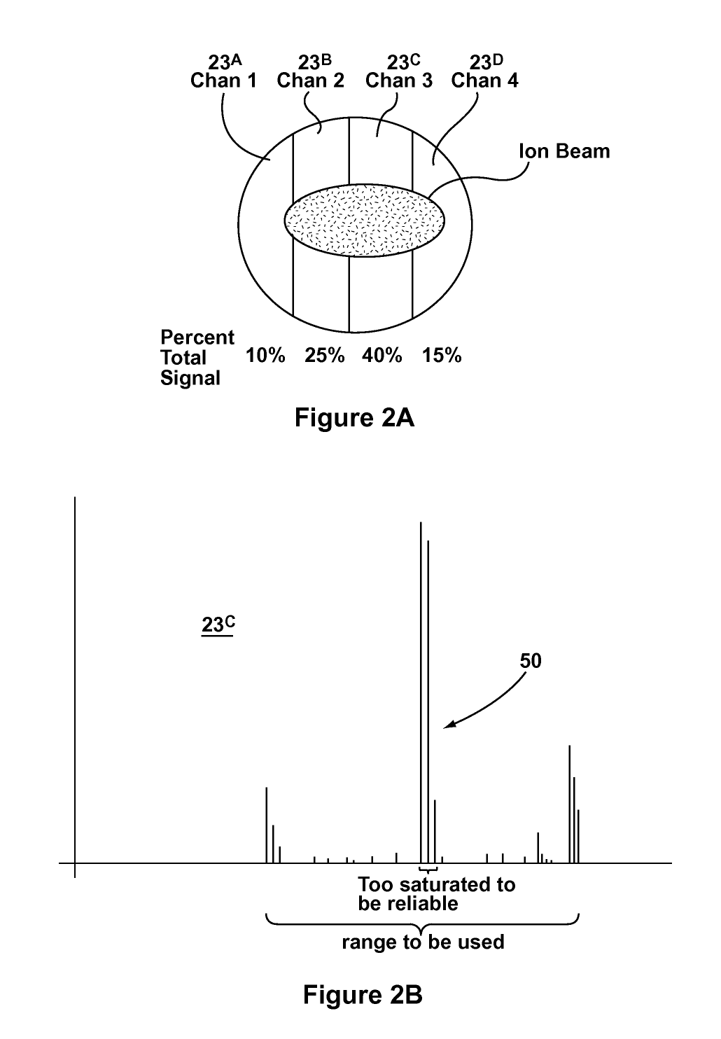

Referring now to FIG. 2A, illustrated in FIG. 2A is a schematic representation of a beam of ions 25 impacting the first channel 23^{A}, second channel 23^{B}, third channel 23^{C} and fourth channel 23^{D} of the detector 22. In the example illustrated, the beam 25 is not evenly distributed across all of the channels 23^{A}, 23^{B}, 23^{C}, 23^{D}. As will be discussed in greater detail below, it is preferable if one channel “receives” a substantially greater number of ions—preferably double and even more preferably if the difference is an order of magnitude. FIG. 2B illustrates a TOF mass spectrum from the third channel of FIGS. 1 and 2A.

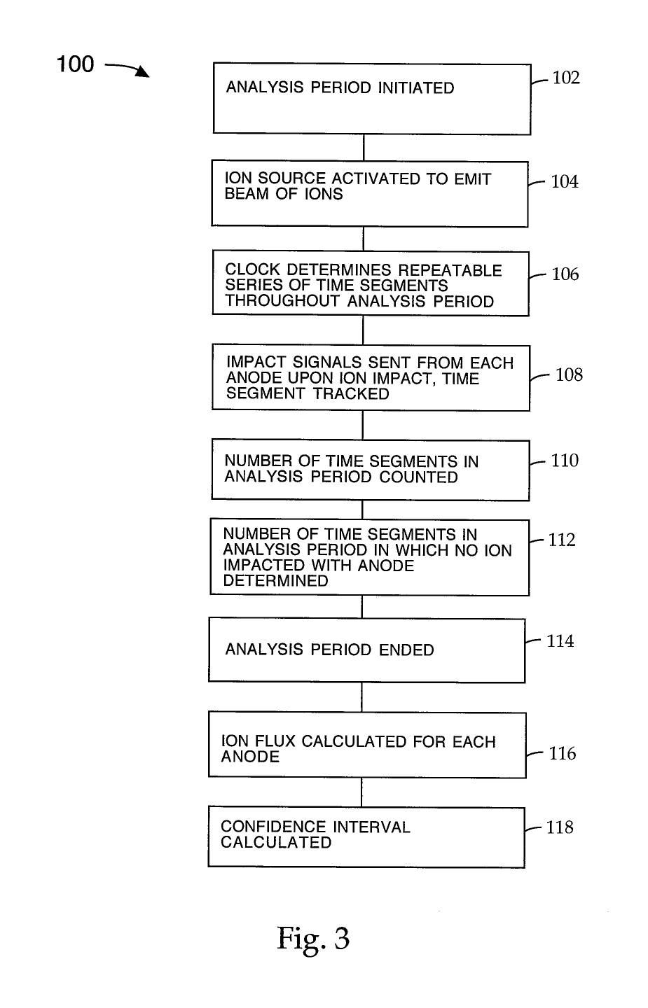

FIG. 3 sets out the steps of the method, referred to generally as 100, carried out by the spectrometer system 10 during an analysis period. Upon receipt of a command by the user to commence an analysis period (typically via the I/O device), the computation engine 14 is programmed to initiate an analysis period (Block 102). When an analysis period is commenced, a beam of ions is emitted from the ion source 20 (Block 104). As noted previously, these ions can be emitted in a series of pulses or as a continuous stream. If a continuous stream of ions is emitted, then as will be understood, the ion source will include a pulser module which will be utilized to generate pulses of ions (and control the start time of flight).

Typically, before the analysis period is commenced, the engine 14 causes the clock 18 to determine a repeatable series of bins, the series of bins can be repeated during the analysis period (Block 106). It is not necessary that the bin period of each bin in the repeatable series be of equal length to every other bin. As will be understood, in a TOF mass spectrometer, for example, when the beam of ions is emitted in the form of a pulse (pulsed beam of ions as defined above), for every pulse, the clock 18 creates or tracks a corresponding pulse time segment for each bin in the repeatable series. As a result, the “time of flight” analysis can be made based on the data gathered for corresponding pulse time segments during an analysis period. Typically, bin periods are usually determined to correlate to the anode's 23 “dead” time ie. the time period between an anode 23 detecting an ion impact and resetting to be capable of detecting a subsequent ion impact, which by way of example only may be on the order of 14 ns.

During every pulse, each time one or more ions impact with an anode 23, an impact signal is sent from the anode 23 which is received by the engine 14, and the engine 14 also tracks and stores in data storage 17 bin data corresponding to the pulse time segment in which the impact signal is sent, for that anode 23 (Block 108). The computation engine 14 is also programmed to count or determine the number of pulses in an analysis period (Block 110). Typically, the number of pulses will be predetermined for the application by the user and input into the CPU 12 prior to commencement of the analysis period. For at least one bin in the series, for each anode 23 the computation engine 14 is further programmed to determine the number of corresponding pulse time segments during the analysis period in which no impact signal was received from the anode 23 (Block 112).

For improved accuracy, it is generally preferable if in Block 112 the computation engine 14 is configured to calculate the number of corresponding pulse time segments in which no impact signal was received from the anode 23 and in which the anode 23 was alive and hence capable of detecting an ion impact. As previously noted, once an ion has impacted with an anode 23 on a detector 22, for a brief period of time thereafter (which may typically be approximately 14 ns) that anode 23 (or channel) is “dead” and incapable of detecting the impact of ions. For improved accuracy, therefore, it is preferable if the computation engine 14 excludes corresponding pulse time segments in which an ion impact was detected within the “dead time” for the detector's 22 anodes 23.

Once the analysis period has ended (Block 114), the engine 14 is configured to calculate one or more ion fluxes for the beam of ions from the sample, separately for each anode 23 (Block 116). This is performed by analyzing the ion impact data corresponding to one bin (or range of bins) in the repeatable series. Typically, for each anode 23 the ion flux will be calculated for each discreet m/z bin or interval over the entire mass range covered by the bins in the repeatable series.

As will be understood, when reference is made to “calculating the ion flux” or variations thereof, this is intended to mean calculating an estimate of the real ion flux. The ion flux is correlated to the probability of not detecting an ion during a pulse time segment. Preferably, the ion flux is calculated according to the following equation:
ψ*=−ln(p(x=0)) (EQ. 1)
where ψ* represents the estimated ion flux (as contrasted with ψ, representing the real ion flux); and where p(x=0) represents the probability of not detecting an ion (as determined by the computation engine 14 in Block 112) during the pulse time segments corresponding to a particular bin (or interval of bins) in the repeatable series.

The engine 14 may also be configured to calculate the confidence interval for the ion flux calculated pursuant to EQ. 1 (Block 118). Confidence may first be calculated according to the following equation:
p(|2\sqrt{ψ*}−2\sqrt{ψ}|<c)≈2Φ(c\sqrt{n})−1 (EQ. 2)
where:
c is a small number determined by the user;
n is the number of pulses the detector 22 was not dead;
2Φ(c\sqrt{n})−1 represents confidence (in the range 0-1); and
Φ(c\sqrt{n}) is the integral of normal distribution PDF over the interval (−∞,c\sqrt{n}).

It is more convenient to define the difference between ψ* and ψ than \sqrt{ψ*} and \sqrt{ψ}. If flux tolerance t is defined according to the equation:
t=|ψ−ψ*|/ψ, (EQ. 3)
then c, the confidence interval, may be calculated according to the following equation:
c=2(\sqrt{ψ*}−\sqrt{(1−t)ψ*}) (EQ. 4)
where c represents the confidence interval, ψ* represents the estimated ion flux calculated in EQ. 1; and where t represents tolerance or desired relative error for the estimated ion flux (as input by the user via the I/O device 16).

By way of background explanation, because of differences in initial ion velocity, beam focusing (and some other effects), ions of the same m/z (mass/charge) will not impact with the detector 22 at the same instance of time (i.e. within the same time bin or pulse time segment corresponding to the same bin in the repeatable series) in TOF instruments. It is assumed that the difference between the measured m/z of an ion and the actual m/z, (recorded m/z−true m/z) is a random variable and has a normal distribution with mean=0 and standard deviation σ, where the value of a depends on the characteristics of the system 10, but is irrelevant for the model, it is only important that σ remains the same during the analysis, which is a valid assumption. It is also assumed that ions will resemble that distribution for any pulse, and that flux is constant over the pulse coordinate for each bin in the repeatable series.

Ion detection for each bin can be modeled as a Poisson process with parameter λ equal to ion flux at corresponding bin.

$$p ( x ) = \{ \begin{matrix}\frac{{ⅇ}^{- λ} {λ}^{x}}{x !} & x = 0 , 1 , 2 , … , \\ 0 & otherwise\end{matrix} \qquad ( EQ . 5 )$$

Ion flux may be calculated according to the following equation:

$${ψ}^{*} = \frac{( number of counts )}{( number of pulses anode\_ 23 was alive )} \qquad ( EQ . 6 )$$

where ψ* is an estimation of real ion flux ψ. If the detector 22 could detect as many ions as emitted, then the reliability of ψ* would depend on the population size (ie. the number of pulses the detector 22 (or anode 23) was not dead) only.

In reality, measured ion flux is always equal or smaller than ψ because of the limitations of detectors 22 as explained above. For example, if two ions land on a detector 22 having four equally-sized anodes 23, the probability of detecting both ions is 0.75, assuming all four anodes 23 were alive. The probability of detecting and counting all ions impacting with the detector 22 (up to 4) decreases even more with a greater number of ions. This example shows how unreliable flux estimation by Equation 6, above, is.

Alternatively, if 0 ions land on anode 23, 0 is counted, or:

$$p ( x = 0 ) = \frac{( number of '' zero - counts '' )}{( number of pulses anode\_ 23 was alive )} \qquad ( EQ . 7 )$$

Probability p(0) is a reliable statistic with respect to the number of emitted ions.

Assuming that ions impacting with the detector 22 (and not counting) is a Poisson process with parameter λ=ψ, where ψ is real ion flux, Equation 1 may be derived from Equations 5 and 7.

By measuring probability of “zero-counts”, real ion flux can be estimated from Equation 1 more reliably than from Equation 6.

Once the ion flux or ion abundance data has been calculated for each detector channel 23^{A}, 23^{B}, 23^{C}, 23^{D} pursuant to Block 116, and the ion flux computation engine 14 has also determined the confidence interval for each channel's 23^{A}, 23^{B}, 23^{C}, 23^{D} ion abundance data pursuant to Block 118, the engine 14 is further programmed to utilize each of these data points in calculating ion flux as will be discussed below.

As will be understood, the higher the abundance of ions registered by a channel 23^{A}, 23^{B}, 23^{C}, 23^{D}, the greater the amount of time that the channel 23^{A}, 23^{B}, 23^{C}, 23^{D} is dead and unable to detect ion impact. As a channel's 23^{A}, 23^{B}, 23^{C}, 23^{D} dead time approaches 100%, the accuracy of the abundance data for that channel 23^{A}, 23^{B}, 23^{C}, 23^{D} decreases significantly.

However, if the ion beam is not evenly distributed across all of the channels 23^{A}, 23^{B}, 23^{C}, 23^{D}, other channels 23^{A}, 23^{B}, 23^{C}, 23^{D} may have more accurate ion abundance data. Referring to FIG. 2A, for example, as can be seen in the illustration, the third channel 23^{C} receives a much higher volume of ions than the first channel 23^{A}. Accordingly, it will be understood that if the accuracy of the abundance data for the third channel 23^{C} is low because of ion saturation, the abundance data for the first channel 23^{A} may be reliable.

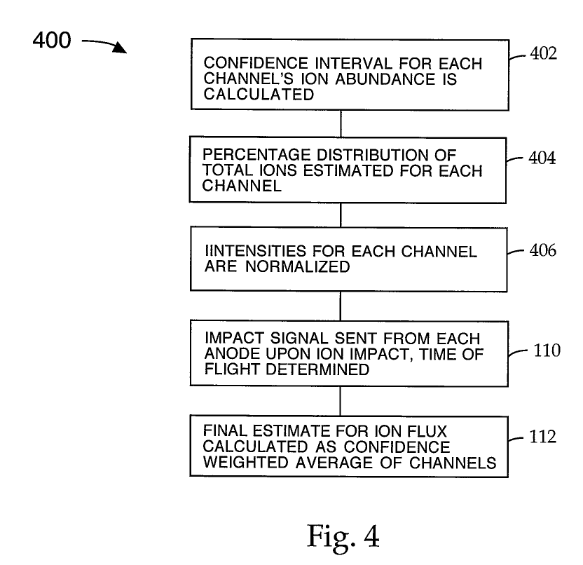

Turning now to FIGS. 2B and 4, as noted above, in commencing the method 400 of estimating the total number of ions or ion flux, the confidence interval for each channel's 23^{A}, 23^{B}, 23^{C}, 23^{D} ion abundance data (pursuant to Block 118) is or has been calculated (Block 402). Next, the percentage distribution of the total number of ions for each channel 23^{A}, 23^{B}, 23^{C}, 23^{D} is then estimated (Block 404). Typically the percentage distribution is calculated by summing the counts for each channel 23^{A}, 23^{B}, 23^{C}, 23^{D} across the same range on the same spectrum. Any portions of the spectrum 50 which exceed the saturation threshold for any channel 23^{A}, 23^{B}, 23^{C}, 23^{D}, are excluded from counting for all channels. For example, the portion 50 on the third channel 23^{C}, may be saturated and hence not reliable. The corresponding portions of the spectrum would not be considered in the ion count totals for the different channels 23^{A}, 23^{B}, 23^{C}, 23^{D}.

Referring to Table 1, below, example counts for four channels 23^{A}, 23^{B}, 23^{C}, 23^{D} are provided. The counts as indicated in Table 1 may then be used to estimate the percentage distribution for each channel 23^{A}, 23^{B}, 23^{C}, 23^{D}, resulting in respective values of 10%, 25%, 40% and 15%. As will be understood, this percentage distribution estimation process may be performed dynamically, on each spectrum, or only once at the beginning of a sample acquisition.

TABLE 1

| | | | Corrected | |
|---|---|---|---|---|
| | | % of | Abundance | |
| Channel | Abundance | Signal | Estimate | Confidence |
| 1 | 1000 | 10% | 10,000 | 98% |
| 2 | 2400 | 25% | 9,600 | 75% |
| 3 | 3500 | 40% | 8,750 | 35% |
| 4 | 1505 | 15% | 10,033 | 99% |

From these percentages, it can be seen that in the example, the channel receiving the largest number of ions (or signal), the third channel 23^{C} at 40% receives four times the signal that the channel receiving the smallest signal, in this example the first channel 23^{A} at 10%. Preferably, the ratio between the largest signal and the smallest signal would be on the order of 10 times and may even be greater, but smaller ratios including at least on the order of 2 times or even less may be acceptable.

The intensities for each channel 23^{A}, 23^{B}, 23^{C}, 23^{D} are then normalized so that each value is relative to the same scale (Block 406). As illustrated on Table 1, the abundance values for each channel 23^{A}, 23^{B}, 23^{C}, 23^{D} are divided by the percentage distribution values calculated in Block 404, to arrive at the normalized intensity values (referred to as “corrected abundance estimates” on Table 1).

The final estimate of the population may be calculated as a confidence weighted average of the estimates from each channel 23^{A}, 23^{B}, 23^{C}, 23^{D} (Block 408). As will be understood, this calculation may be performed by summing the totals of each corrected abundance estimate as multiplied by its corresponding confidence interval, and dividing the sum by the total of the confidence values. Thus for the example data set out in Table 1, the final ion population or ion flux estimation is calculated as:

$$\frac{\begin{matrix}( 10000 * 98 ) + ( 9600 * 75 ) + \\ ( 8750 * 35 ) + ( 10033 * 99 )\end{matrix}}{( 98 + 75 + 35 + 99 )} = 9770.41 \qquad EQ . 10$$

As can be seen from the above calculation, in this example, the data from the first 23^{A} and fourth 23^{D} channels are given the most weight.

Thus, while what is shown and described herein constitute preferred embodiments of the subject invention, it should be understood that various changes can be made without departing from the subject invention, the scope of which is defined in the appended claims.

1. A method for calculating ion flux using a mass spectrometer having a plurality of detector channels, said method comprising the steps of:
(a) determining ion abundance data correlated to each detector channel;
(b) determining corrected ion abundance data correlated to each detector channel;
(c) determining confidence data corresponding to the ion abundance data for each detector channel;
(d) determining a confidence weighted ion abundance estimate of the ion flux for all of the detector channels correlated to both the ion abundance data and to the confidence data for each detector channel.

2. The method of calculating ion flux as claimed in claim 1, wherein the spectrometer is configured such that the ion abundance data correlated to a first detector channel from the selected plurality of the detector channels is substantially greater than the ion abundance data correlated to a second detector channel from the selected plurality of detector channels.

3. The method of calculating ion flux as claimed in claim 2, wherein the ion abundance data correlated to the first detector channel is at least double the ion abundance data correlated to the second detector channel.

4. The method for calculating ion flux as claimed in claim 1, said method further comprising the steps of:
(a) generating a plurality of pulses, wherein during each pulse a beam of ions is emitted from a sample to be analyzed;
(b) determining a repeatable series of bins, wherein each bin in the repeatable series will correspond to a corresponding pulse time segment in every pulse;
(c) detecting the impact of ions on a detector during each pulse;
(d) determining the total number of pulses during the analysis period;
(e) for at least one bin in the repeatable series, determining the number of corresponding pulse time segments in which no ion impact was detected; and
(f) calculating the ion flux, wherein said ion flux is correlated to the probability of not detecting an ion impact during pulse time segments which correspond to the at least one bin in the repeatable series.

5. The method as claimed in claim 4, wherein the ion flux is calculated substantially according to the following equation: ψ=ln(p(x=0))
(a) wherein ψ represents the ion flux; and
(b) wherein p(x=0) represents the probability of not detecting an ion impact during pulse time segments which correspond to the at least one bin in the repeatable series.

6. A method for calculating ion flux for a sample, said method comprising the steps of:
(a) emitting ions from the sample during a plurality of pulses;
(b) detecting the impact of ions through a plurality of detector channels;
(c) determining ion abundance data correlated to each of the plurality of detector channels;
(d) determining corrected ion abundance data corresponding to each of the plurality of detector channels;
(e) determining confidence data corresponding to the ion abundance data for each of the selected plurality of detector channels;
(f) determining a confidence weighted abundance estimate of the ion flux correlated to both the ion abundance data and to the confidence data.

7. A mass spectrometer comprising:
(a) an ion source for emitting a beam of ions from a sample;
(b) at least one detector positioned downstream of said ion source;
(c) wherein said at least one detector comprises a plurality of detector channels;
(d) a controller operatively coupled to the plurality of detector channels, wherein the controller is configured to:
(i) determine ion abundance data correlated to each detector channel;
(ii) determine corrected ion abundance data correlated to each detector channel;
(iii) determine confidence data corresponding to the ion abundance data for each of the detector channels;
(iv) determine a confidence weighted abundance estimate of the ion flux correlated to both the ion abundance data and to the confidence data.

8. The mass spectrometer as claimed in claim 7, wherein the plurality of detector channels are configured such that the number of ions detected by a first detector channel is substantially greater than the number of ions detected by a second detector channel.

9. The mass spectrometer as claimed in claim 8, wherein the plurality of detector channels are configured such that the number of ions detected by the first detector channel is at least double the number of ions detected by the second detector channel.
